(19) United States
(12) Patent Application Publication
(10) Pub. No.: US 2005/0114608 A1
(43) Pub. Date: May 26, 2005

(54) Storage device having a capability of learning access patterns

(75) Inventors: Satoshi Oshima, Tachikawa (JP); Shinji Kimura, Sagamihara (JP); Ikuko Kobayashi, Kawasaki (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/769,030

(22) Filed: Jan. 30, 2004

(30) Foreign Application Priority Data
Nov. 26, 2003 (JP) 2003-394920

(51) Int. Cl. G06F 12/00

(52) U.S. Cl. 711/137; 711/113

(57) ABSTRACT

A storage device has a capability of learning access patterns by which a plurality of computers access to the device. The storage device stores a specific access history for each computer and causes a management computer to report a type of file access. This allows the storage device to save information in a cache memory before start of a file access to be executed by the computer.

### BACKGROUND OF THE INVENTION

The present invention relates to a method of reading information from a disk device out to a computer in a storage device to be used for a plurality of computers, a method of designating the read, and a computer for executing the designating method.

As a technology of improving a data transfer rate in the conventional storage device, a read-ahead technology has been devised which technology is described in, for example, JP-A-01-082239. The word “read-ahead” termed herein means an operation of the storage device of pre-reading data to be likely designated to be read out by an external device from a storage medium to another one. For example, the 082239 publication discloses the following reading operation: In response to a data readout designation to be given from a computer, the storage device operates to read out the designated data and the data following the designated data by a predetermined length, for example, several blocks, from a physical location of a storage medium such as a disk device in which the designated data is stored. The storage device saves the read data in a cache memory with a faster readout speed than the disk device or the like.

The read-ahead operation eliminates the necessity of reading data from the disk device or the like in the case of reading out the data temporarily saved in the cache memory. Further, since the data is read out of the cache memory, the data transfer rate is improved.

Further, JP-A-03-102443 discloses the technology which improves the read-ahead performance and makes the efficient use of the storage medium to be used for the read-ahead possible. In this technology, in the read-ahead operation (often referred simply to as the read-ahead), the storage device determines if the access pattern of a computer that uses the storage device is a sequential read access or a random read access based on a history of a predetermined number of accesses. Then, if the access pattern is determined to be the sequential read access that is more effective in the read-ahead, the storage device executes the read-ahead operation. This makes it possible to improve the read-ahead performance in the sequential read access and more efficiently use the storage medium to be used for the read-ahead.

Further, JP-A-10-091497 discloses the technology of improving the performance of pre-reading a file in the storage device. In this technology, the storage device pre-records an information on the history regarding access operation to physical location of the storage device, and the device performs an operation of pre-reading a file by using this history information even if the access pattern is not the sequential read access but the random read access.

Further, JP-A-08-87435 discloses the technology of providing a plurality of read-ahead buffers in a file server device for the purpose of controlling the read-ahead for each terminal.

In the prior art, as mentioned above, the storage device determines the access pattern to be given from the computer based on the access history and then performs the read-ahead when the access pattern is determined to be the sequential read access.

In the other prior art, if the access pattern is the random read access, the storage device compares a file reading command with the information on the physical location recorded in the storage device. And, if the read-ahead is determined to be possible based on the compared result, the storage device executes the read-ahead operation.

In the foregoing prior arts, however, in a case that a plurality of computers share one storage device, if two or more of these computers access one storage device, the storage device disables to manage each access history for each computer only based on the access history and the information on the physical location in the storage device. That is, if a plurality of computers request the random read access pattern, the storage device obtains the access history without classifying the access histories for each computer. Hence, it is quite difficult to determine that the access is executed on the random access pattern based on the access history.

In order to solve the aforementioned problem, JP-A-08-87435 discloses the method of collecting access histories by locating in a file server a processor or a buffer for collecting access histories for each terminal. However, location of lots of processors or buffers in the file sever or the storage device makes the overall storage device more costly. This is not preferable.

Further, the foregoing prior art is arranged to collect history information on the physical location to be accessed in the random read access. If the prior art includes the method of designating the start or the end of the history information collection to the storage device, the storage device is required to collect a massive amount of histories and detect the common history from the collection. This burdens the process with heavy load.

In the prior art, the storage device does not start the read-ahead operation until the sequential access or the access stored as a history is required by the storage device. However, the prior art does not consider the read-ahead operation in the case of the start of the computer or the start of an application program caused by job management software.

### SUMMARY OF THE INVENTION

An object of the invention is to reduce the load on management of an access history in the storage device, the area of managing the access history, and improving the reading performance.

According to an aspect of the invention, in order to solve the foregoing problems, the storage device is inputted with information for identifying a computer and information for specifying a history and records the access history of a computer to be specified on the inputted information in linkage with the information for specifying the history. Then, when the information for identifying the computer and the information for specifying the history are transmitted to the storage device, the storage device performs the read-ahead operation of the data based on the history corresponding with the transmitted information.

The other features of the present invention will be apparent from the present specification and the appended drawings.

### BRIEF DESCRIPTION OF THE DRAWINGS

FIG. 1 is a diagram showing a configuration of a system according to an embodiment of the present invention.

FIG. 2 is a table illustrating an example of a history information saving table.

FIG. 3 is a table illustrating commands to be transferred between a storage device 101 and a management computer 108.

FIG. 4 is a flowchart illustrating a process of collecting access histories in starting a computer.

FIG. 5 is a flowchart illustrating a read-ahead process when a computer is started.

FIG. 6 is a view showing an example of a network packet.

FIG. 7 is a table showing an example of a computer group saving table.

FIG. 8 is a table showing an example of a history management table.

FIG. 9 is a table showing an example of a job management table.

FIG. 10 is a flowchart showing an automated read-ahead process.

### DESCRIPTION OF THE EMBODIMENTS

Hereafter, the description will be expanded on the embodiments of the invention.

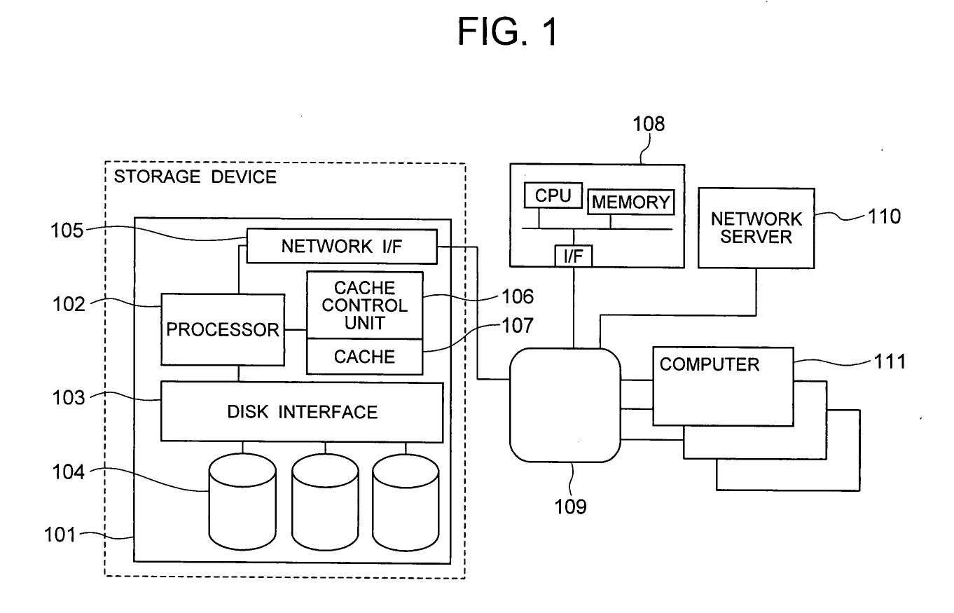

FIG. 1 is a diagram showing an arrangement of a system having a storage device to which the present invention applies.

The system as shown in FIG. 1 includes a storage device 101, a management computer 108, a network server 110, and a plurality of computers 111 to be used by the user of the system. Those devices are connected with one another through a network 109.

The computer 111 or the management computer 108 is a general-purpose computer provided with a processor, a memory, I/O units, and so forth.

The plurality of computers 111 share the storage device 101. Hence, the computers 111 read the data, the application programs, and the operating system from the storage device 101, and then use them.

The storage device 101 includes a plurality of disk devices 104, a processor 102 for controlling the plurality of disk devices 104 (referred to as a disk group), a disk interface 103 for controlling transfer of data between the processor and the disk group, a network interface 105 connected with a network 109 for exchanging information with the computer 111, a cache memory 107 for holding data to be read out of the disk device 104 or to be saved therein, and a cache control unit 106 for saving information used for controlling the cache memory 107.

The storage device 101 operates to exchange information with the management computer 108, the network server 110, and the computer 111 through the network 109.

In this embodiment, the storage device 101 obtains an access history such as data readout from the storage device 101 for each computer 111 and then stores the access history for each computer in the cache control unit 106. Then, the storage device executes the read-ahead of the data in the disk group 104 and puts it in the cache memory 107. The arrangement of the storage device 101 is not limited to the foregoing arrangement. The necessary components in the arrangement is only the control unit, the disk device(s), and the cache memory 107.

In this embodiment, the processor 102 controls the cache memory 107 of the storage device 101 based on the management information and the management program to be saved in the cache control unit 106.

Also in this embodiment, the cache control unit 106 is composed of a nonvolatile semiconductor memory and the cache memory 107 is composed of a volatile semiconductor memory. In order to prevent loss of data to be saved in the cache memory 107, the cache memory 107 may be composed of a nonvolatile memory. Or an arrangement for constantly securing a power (for example, a spared power source) may be added to the volatile cache memory.

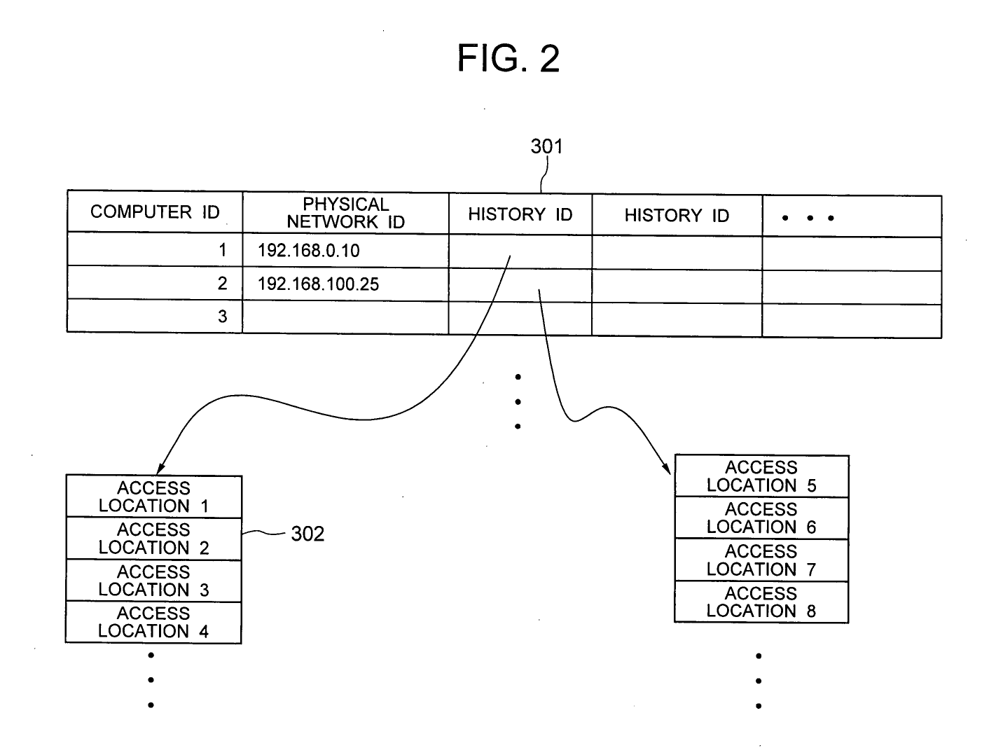

FIG. 2 shows an exemplary configuration of a history information saving table in this embodiment. The history information saving table saves information on the access history to the storage device 101 for each computer 111. Further, the history information saving table is saved in the cache control unit 106. The history information saving table includes a history information management table 301 and a history information saving list 302.

For each access to be given by the computer 111, the storage device 101 determines if the access is given by the computer 111 that is designated to collect the history by the management computer 108. If the access is given for collecting the history, the content of the access is added to the history information saving list 302 as a new access history. In this case, the processor 102 of the storage device 101 is linked with the history information management table 301 and the added access history. The history information saving list 302 is managed by the history information management table 301.

The history information management table 301 includes the corresponding entry to each computer 111 that uses the storage device 101. Each entry includes a field in which a computer ID allocated to the computer 111 for the entry is registered, another field in which a physical network ID allocated to the computer 111 for the entry is registered, and a plurality of fields in which the history IDs are registered. Herein, the computer ID means an identifier to be allocated to the computer 111 by the management computer 108. In this embodiment, as the computer ID is used the MAC (Media Access Control) address or the World Wide Name to be properly allocated to the computer. The computer ID is not limited to them.

The physical network ID is an identifier to be given to the computer 111 in the network inside the system of this embodiment. As an example of the physical network ID, an IP address used in the internet protocol, or a World Wide Name or a MAC address to be individually given to each computer 111 may be referred. In addition, these illustrated identifiers may be dynamically given by another computer, for example, the network server 110 each time the computer is started 111. In this case, each time the identifier is dynamically given, the storage device 101 updates information of the physical network ID in the history information management table 301.

The history ID can be an identifier allocated to each access pattern for identifying an access pattern to the storage device 101 to be given by the computer 111, for example, a sequential access, a random access, or an access pattern to the storage device 101 when the computer 111 is started. Since the plurality of computers 111 may provide the same access patterns, the same history ID may be registered in the field in which the history ID for each entry of the history information management table 301 is to be registered.

The entry for each computer 111 included in the history information management table 301 has a plurality of fields for registering the history ID, for the purpose of managing a plurality of access patterns to be given to the storage device 101 of the computer 111, respectively.

The history information saving list 302 is linked with the history ID described in the history information management table 301 and includes a plurality of access histories registered therein. When an access is received by the storage device 101, each access history includes the information for indicating the access location at which the data is read out of the disk group 104 by the storage device 101.

The access histories saved in the history information management list 302 are linked with one another through the use of the link structure and the fields in which the history IDs for the access histories listed in the history information management table 301 are registered. This link makes it possible for the storage device 101 to manage each access history registered in the history information management list 302 through the use of the history ID, concretely, to grasp the corresponding access pattern of the corresponding computer 111 with each access history. As mentioned above, this linkage is established as follows: When the storage device 101 accepts a certain access request from each computer 111, the storage device 101 registers the access history in the history information management list 302 and links the access history registered in the history information management list 302 with the field of the corresponding history ID of the corresponding computer 111 with the access history.

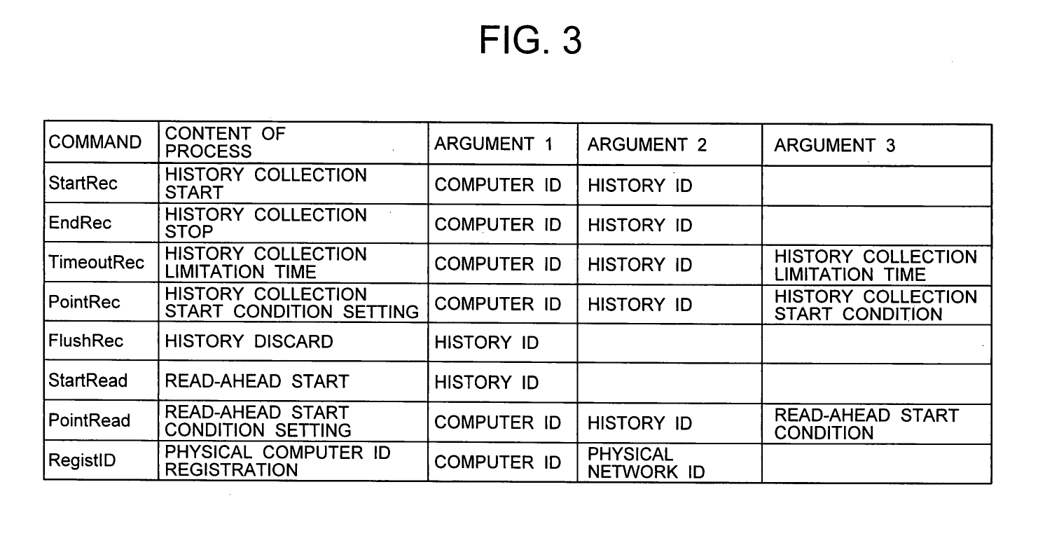

FIG. 3 is a table showing exemplary commands to be transferred between the storage device 101 of this embodiment and the management computer 108. The user of the management computer 108, for example, the administrator of this system enables to control the operations such as start, end, and read-ahead start of the access history collection in the storage device 101 by causing the management computer 108 to transmit these commands to the storage device 101. Hereafter, each command will be briefly described.

A command “StartRec” is used for specifying a computer ID and a history ID and then designating the start of the access history collection of the computer 111 specified by the computer ID to the storage device 101. The specified history ID is added to the collected access history.

A command “EndRec” is used for specifying a computer ID and a history ID and designating the end of the access history collection of the computer 111 specified by the computer ID to the storage device 101.

A command “TimeoutRec” is used for specifying a computer ID, a history ID, and a time and specifying to the storage device 101 a limitation time such as a time when the access history collection is automatically stopped if a certain length of time is passed since the access start or a time when the access history collection is stopped if an access is ceased a predetermined time later than the access start.

A command “PointRec” is used for specifying a computer ID, a history ID, and a condition of starting history collection such as read from and write to a specific location of the storage device or read from a consecutive specific locations and, if the specified history collection start condition is met, designating the storage device 101 to start the access history collection of the computer 111 specified by the computer ID without the StartRec command given by the management computer 108.

A command “FlushRec” is used for specifying a computer ID and a history ID and designating the storage device 101 to erase the access history registered in the history information saving list 302 saved in the cache control unit 106 defined by the specified computer ID and history ID.

A command “StartRead” is used for specifying a computer ID and a history ID and designating the storage device 101 to execute the read-ahead operation of the disk group into the cache memory 107 based on the access pattern of the corresponding computer 111 with the specified computer ID and history ID.

A command “PointRead” is used for specifying a computer ID, a history ID and a read-ahead starting condition, and, if the read-ahead starting condition is met, designating the storage device 101 to start the read-ahead of data from the disk group to the cache memory 107 based on the access pattern of the specified computer 111 without the StartRead command given by the management computer 108.

A command “RegistID” is used when the management computer 108 notifies the storage device 101 of a new physical network ID of the corresponding computer 111 with the computer ID that is uniquely matched to the computer 111 if the physical network ID of the computer 111 is dynamically changed through the use of the DHCP (Dynamic Host Configuration Protocol). As another method of causing the storage device 101 to make the computer ID correspond with the physical network ID, it is possible to employ a method of causing the processor 102 of the storage device 101 to monitor the protocol of the DHCP through the network interface 105, detect obtention of the physical network ID by the computer 111, and then obtain the physical network ID.

In such a narrow network that no communication through a router is necessary, the MAC address and the World Wide Name, both of which are not dynamically changed, may be assigned to the computer ID and the physical network ID. However, if the communication uses the router, the MAC address and the World Wide Name owned by the computer 111 do not reach the storage device 101. Hence, they cannot be used for the physical network ID.

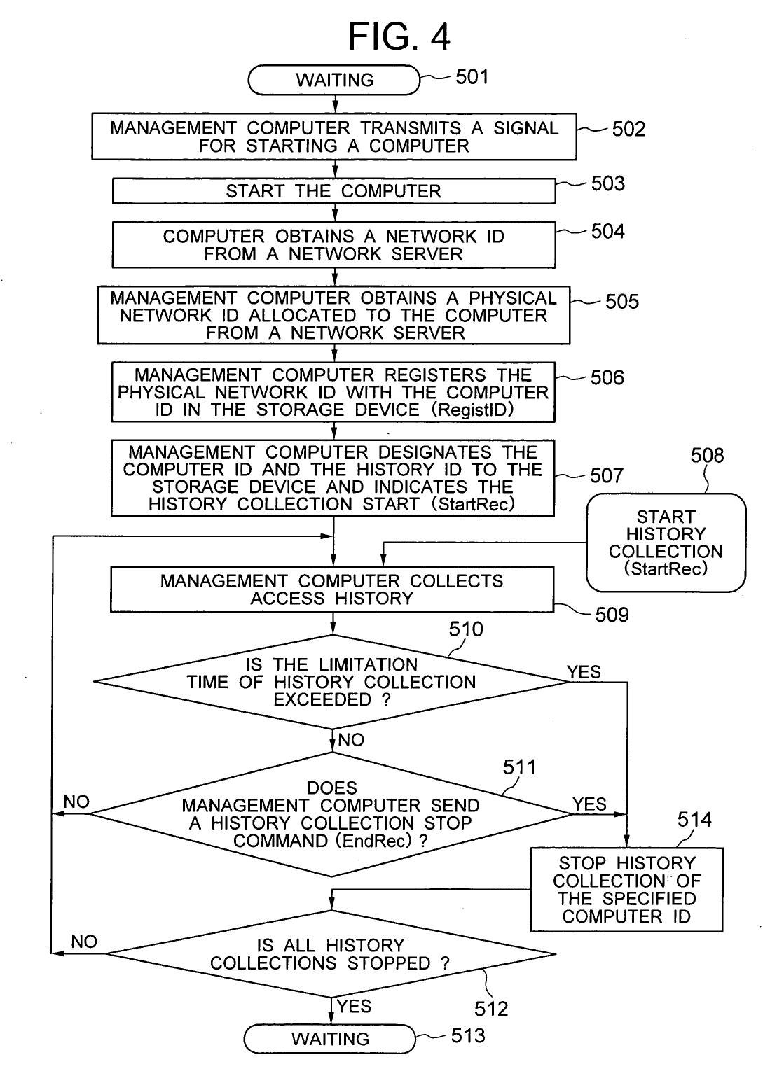

FIG. 4 is a flowchart showing a process of collecting an access history when the computer 111 is started in the present embodiment. Herein, the description will be oriented to the process of collecting an access history when the computer 111 is started. The access history collection timing is optional. As mentioned above, if the storage device 101 receives the StartRec command from the management computer 108, the storage device 101 executes the process of collecting an access history (to be discussed below). It means that it is possible to designate the storage device 101 to start obtention of the access history of the computer before the computer ill is started.

However, if the physical network ID is dynamically allocated to the computer 111, the storage device 101 disables to specify the computer 111 until the assignment of the physical network ID is terminated. Hence, the access history collection is started after the physical network ID is assigned.

Further, the administrator may transmit the “TimeoutRec” command to the storage device 101 through the use of the management computer 108 in advance, for the purpose of specifying to the storage device 101 a limitation time of the collection of the access history corresponding with the specified computer ID and history ID, in other words, the time when the access history collection is completed. For example, by measuring the time taken until the computer 111 enters into the starting state in advance and specifying the time taken until the computer 111 finishes its operation to the storage device 101 before the computer 111 is started, the storage device 101 may obtain the access history only when the computer 111 is started.

Moreover, the administrator causes the storage device 101 to start collection of the access history for the access pattern specified by the specified history ID through the use of the “PointRec” command if the access history collection start condition of the computer 111 with the specific computer ID is met at any step of the process shown in FIG. 4. For example, the administrator may specify the time when the computer 111 starts to read the operating system or the time when it starts to read a specific application program.

In a case that the physical network ID for the computer 111 is dynamically allocated after the computer is started, in the process shown in FIG. 4, the corresponding physical network ID with the computer ID of the computer 111 is determined. Then, after the storage device 101 obtains the information, the storage device 101 determines if the history collection start condition is met. If met, the process specified by the “PointRec” command is started. Hereafter, the process will be described in detail.

At first, the processor 102 of the storage device 101 stays in the waiting state. The processor 102 monitors whether or not there exists a computer 111 that meets the history collection start specified by the management computer 108 and the read-ahead start condition (for example, the start of a specific application program or an OS) specified by the “PointRead” command. Further, the processor 102 may also monitor whether or not there exits a computer 111 that obtains the physical network ID by monitoring the network 109 (step 501).

The management computer 108 transmits a signal for starting the corresponding computer 111 with the computer ID through the network 109 (step 502).

The computer 111 that has received the start signal initiates the starting process (step 503).

In a case that the physical network ID of the computer 111 to be started is dynamically determined and the computer 111 uses the storage device 101 since it is started, the computer 111 obtains the physical network ID from the network server 110. In this case, if the storage device 101 monitors assignment of the physical network ID to this computer 111, the storage device 101 registers in the history information management table 301 the observed physical network ID in linkage with the computer ID of the computer 111 that obtains the physical network ID (step 504).

In a case that the physical network ID of the computer 111 is dynamically determined, the management computer 108 obtains the physical network ID allocated to the computer 111 by the network server 110. Afterwards, the management computer 108 records the relation between the obtained physical network ID and the computer ID of the computer 111 to which the physical network ID is allocated in a memory owned by the management computer 108 itself (step 505).

In a case that the storage device 101 does not monitor assignment of the physical network ID to the computer 111, the management computer 108 notifies the storage device 101 of the corresponding physical network ID with the computer ID through the use of the RegistID command (step 506).

Then, the administrator causes the management computer 108 to specify the computer ID and the history ID to the storage device 101 through the use of the “StartRec” command and then to designate the storage device 101 to start the access history collection (step 508). Herein, the step of starting the access history obtention is described in the location 508 in FIG. 4. However, the history information collection start does not necessarily take place once. The designation of starting the history information collection to the computer with the different computer ID may take place at any step.

When the history collection start is designated, the processor 102 of the storage device 101 selects a request for an access from the computer with the physical network ID from all requests for accesses to the disk group, received by the storage device 101, through the use of the corresponding physical network ID with the computer ID to which the collection is designated and then saves the selected access request in the history information list 302. In the list 302, the history ID specified when the history collection is started is related with the access content saved in the history information list 302.

As shown in FIG. 6, the physical network ID 702 for indicating the transmitter 111 that has transmitted the access request is included in the packets of the access request transmitted by the computer 111. Hence, the access request may be selected in the storage device 101. If the access request is transmitted from the computer 111 with the corresponding physical network ID with the computer ID whose history is not requested to be collected, the access request is not saved (step 509).

If the limitation time is set to the history collection, the processor 102 determines if the access history collection in execution continues over the limitation time (step 510). If yes, the corresponding history information collection with the target computer ID is terminated (step 514).

If not, the processor 102 checks if the history collection stop command “EndRec” is issued by the management computer 108 (step 511). If issued, the processor 102 terminates the corresponding history information collection with the target computer ID (step 514). If not issued, the processor 102 repeats the process of the step 509 or later.

After the history collection is stopped in the step 514, the processor 102 checks if the overall history information collection is stopped. If yes, the processor 102 shifts into the waiting state, while if no, the processor repeats the process of the step 509 or later (step 512).

If no dynamic change of the physical network ID takes place, when the access history collection is designated to the storage device 101 again after the process (steps 502 to 507) of obtaining the information of the physical network ID is ended once, the process of the step 507 or later is performed. On the other hand, if the dynamic change of the physical network ID takes place, when the history information collection is designated to the storage device 101 again, the process of the step 504 or later is performed.

If the physical network ID is specified (not dynamically) in advance, the designation for the history information collection may be executed at the step 506 or later.

Further, a plurality of history collection designations may be given to the storage device 101. In this case, the storage device 101 collects a plurality of access histories in parallel. For this purpose, the number of the computers to be used may be singular or plural. Moreover, if another computer 111 is started while the storage device 101 is collecting the access histories of a certain computer 111, the process shown in FIG. 6 to the newly started computer 111 is executed in parallel to the collection of the access histories.

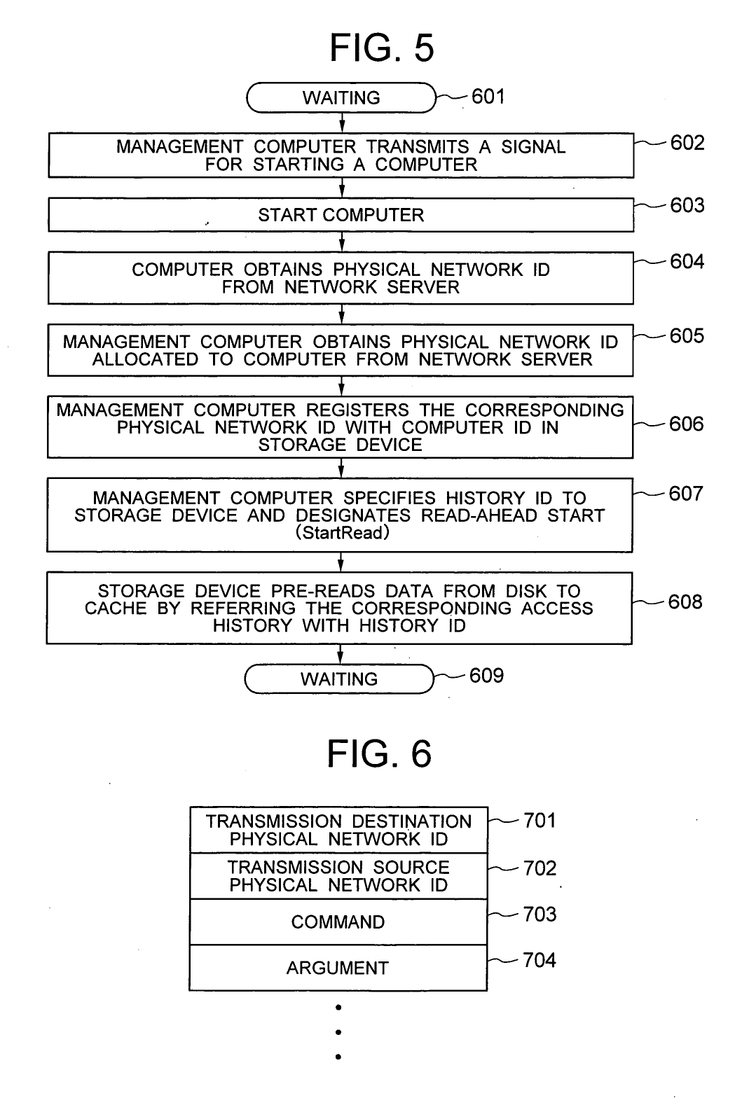

FIG. 5 is a flowchart showing a process of causing the management computer 108 to designate the storage device 101 to execute the read-ahead operation of the disk device 104 to the cache memory 107 when the computer 111 is started through the use of the history-collected result. The process of the steps 601 to 606 is the same as the process of the steps 501 to 506 in collecting the history information.

The administrator causes the management computer 108 to transmit the “StartRec” command for indicating the read-ahead start to the storage device 101, specify the history ID, and designate the storage device 101 to start the read-ahead operation. (step 607).

The storage device 101 operates to refer to the history information management table 301 and execute the read-ahead of the disk group into the cache memory 107 through the use of the access history of the corresponding history information list 302 with the designated history ID. Specifically, the storage device 101 operates to retrieve the access history of the history information list 302 related with the designated computer ID and history ID, read out data from an access location, i.e. an address, to the disk group 104, which is registered in each retrieved access history, and then save the data in the cache memory 107. If a plurality of access histories correspond with the history ID, the storage device 101 also operates to sequentially read out the corresponding data with those access histories (step 608).

If no access history corresponding with the designated history ID is found (all are read out or nothing is originally registered), the storage device 101 terminates the read-ahead operation and then returns into the waiting state (step 609).

The system administrator may cause the management computer 108 to designate the storage device 101 to execute the read-ahead operation in the other time rather than the time when the computer 111 is started. In this case, if the physical network ID is not dynamically changed or not dynamic, the process of designating the storage device 101 to execute the read-ahead operation is executed from the step 607. If the physical network ID is dynamically changed, the process is executed from the step 604.

Further, the system administrator may transmit a plurality of read-ahead designations to the storage device. In this case, the storage device 101 executes the read-ahead of data based on the corresponding access histories with the specified read-ahead designations.

The description has been heretofore expanded on the assumption that the system administrator directly inputs the history ID and the computer ID to the management computer 108. However, as the computers 111 that use the storage device 101 has increased in number, it is not realistic that the administrator directly inputs the history ID and the computer ID to the management computer 108. Hereafter, the description will be expanded about the embodiment in which the system administrator may more easily manage the history ID and the computer ID.

In this embodiment, for simplifying the access history management and thereby reducing the burden of the management, the management computer 108 is provided with a history management program. The management computer 108 causes the history management program to execute the read-ahead schedule management by managing the computer ID and the history ID and designating the history ID to the storage device 101.

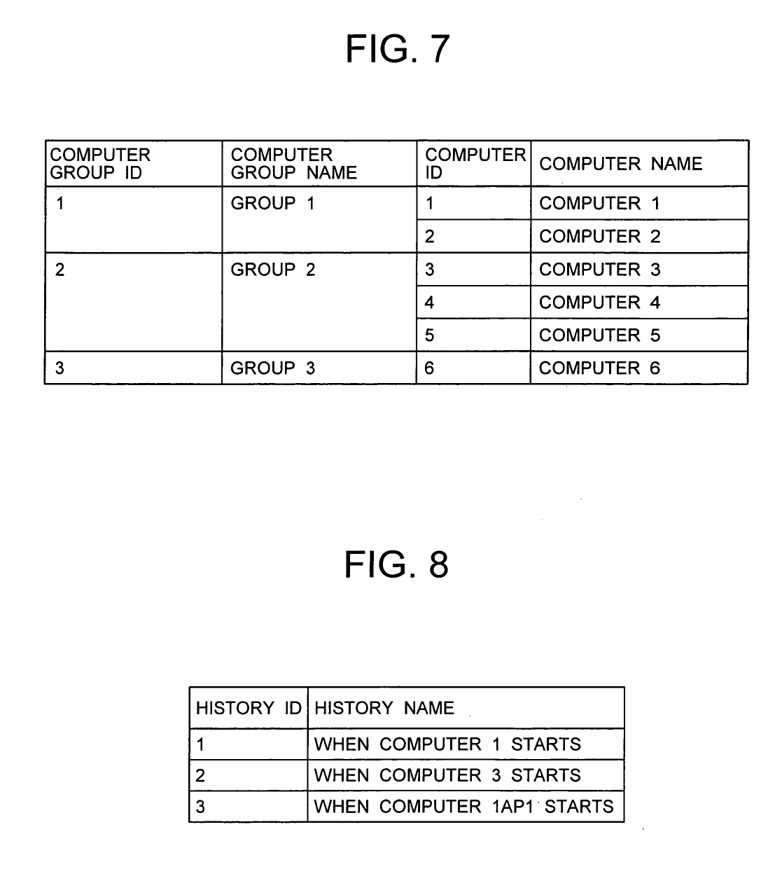

FIG. 7 is a table showing the information included in the management computer 108 for managing the computer 111 that uses the storage device 101.

Herein, the information is managed in the form of the table (referred to as the “management table”). The system administrator inputs the information for specifying the computer(s) 111 that use(s) the storage device 101, herein, the computer name(s) and the computer ID(s) through an input interface (such as an input screen) included in the management computer 108. The management computer 108 registers in the management table the inputted computer ID(s) and computer names as being linked with the physical network ID. In this case, if the currently inputted computer name and ID are newly inputted, the management computer 108 may display a warning to a person who inputs the data.

As another method, the management computer 108 is programmed to obtain the corresponding information of the computer ID and the physical network ID from the network server and display the data on the screen of the management computer 108 itself so that the system administrator may select the computer ID and the physical network ID and then input the corresponding computer name on the screen.

Moreover, the administrator may classify a plurality of computers into some groups, for more facilitating management of those computers. In this case, the administrator inputs to the management computer 108 the plurality of computer names and a computer group name for managing them at a batch. The management computer 108 operates to allocate an identifier (computer group ID) to each computer group name and then register in the management table the computer group name and the computer names and the computer IDs included in the group as being linked with one another. Further, the management computer 108 is caused to display on the screen a list of computer names registered in the management table so that the administrator may select the proper computer names and register them as one computer group.

As set forth above, since one or more computers 111 may be managed with the name the system administrator may more easily leave in mind, it is possible to lessen the administrator's burden of specifying the computer when he or she designates the storage device 101 to execute the read-ahead or collect the history information. Moreover, the read-ahead designations to a plurality of computers may be executed at a batch.

FIG. 8 is a table showing the exemplary information included in the management computer 108 for managing the history ID to be specified to the storage device. Herein, the information is managed in the form of the table (referred to as the “history ID table”).

The administrator registers the collected access pattern as the name (history name) to be easily identified. The management computer 108 allocates the history ID to the inputted history name and then registers in the history ID table the history name and the history ID as being linked with each other. If the existing history name is newly inputted, the management computer 108 may report a warning to a person who inputs the data. Further, the management computer 108 accepts the inputs of the history name and the computer name from the administrator and an input of designating deletion of it and then deletes them.

As mentioned above, the history ID is allowed to be managed by the system administrator in the name that concretely indicates the corresponding access pattern with the history ID. This leads to lessening the burden of the administrator in designating the read-ahead or the collection of the history information.

The foregoing two tables allow the administrator to input the computer name (or the computer group name) and the history name to the management computer 108. This thus makes it possible to more easily designate the storage device 101 to execute the read-ahead operation about a specific computer 111 or collect the history thereabout.

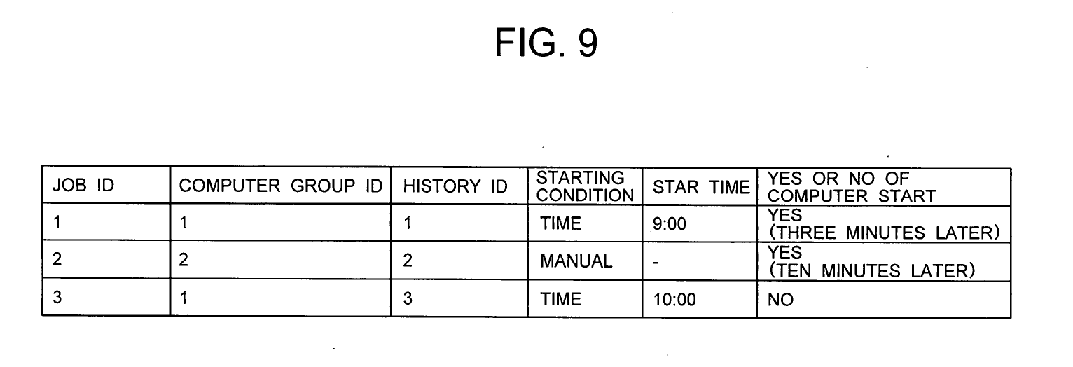

FIG. 9 is a table showing an example of a job management table included in the management computer 108. This job management table is used so that the management computer 108 may manage the schedule for designating a group of processes such as a series of read-ahead designations to the storage device 101. The administrator inputs a series of designations to the storage device 101 into the management computer 108. The concrete contents of the designations include a history ID for indicating the access pattern to be pre-read, a time when the access pattern is to be executed, a computer ID for indicating the target computer 111 (or the computer group), and so forth. Herein, in place of the computer ID, the computer name or the history name may be used.

The management computer 108, which has been inputted with these contents of designations, defines one inputted designation content as one job by linking an identifier of a job ID with the designation content, and then record the job in the job management table. In this case, if a plurality of designation contents are inputted at a time, the same job ID may be allocated to the plurality of designation contents. This allows the system administrator to designate the plurality of designation contents to the storage device 101 with one job ID.

The job management table includes an entry for one job. Each entry includes a plurality of fields. Concretely, they are a field in which a job ID of the corresponding job with an entry is registered, a field in which a computer ID or a computer group ID designated by the job is registered, a field in which a history ID designated by the job is registered, a field in which the job start condition is registered, a field in which the job start time is registered, and a field in which the information for indicating whether or not started is the computer 111 to which the job is oriented.

Herein, for example, as to the job in which the job start condition field included in the job management table is set as “manual”, the job is executed by the job start designation given by the administrator. That is, the management computer 108 designates the content designated by the job to the storage device 101. On the other hand, if a time is specified in the job start condition field, the management computer 108 operates to designate the corresponding content with the job to the storage device 101 when the time reaches the specified time.

If the condition for starting the corresponding computer 111 with the job is specified as the job content after the read-ahead of the data specified by the job, concretely, if “yes (three minutes later)” is specified, the management computer 108 transmits the indication of start to the corresponding computer 111 three minutes later than the time when the read-ahead is designated to the storage device 101.

In the foregoing description, one entry is matched to one job. In place, if one job is matched to a plurality of designation contents, a plurality of entries may be arranged to match to one job. Or, one entry is arranged to match to one job and the information for specifying a plurality of objects, for example, a plurality of history IDs or a plurality of computer IDs may be registered in each field. Further, the job management table includes a field in which the job name for the job ID is registered so that the management computer 108 may retrieve the job if the administrator registers just a job name. In this case, the administrator inputs a job name and thereby registers the job when he or she inputs the content of the job.

Further, in the field where the job execution condition is registered, the other information than “manual” and “time” may be registered. For example, by registering the address and the time to be processed by the “PointRead” command, the job may be created so that the management computer 108 designates the storage device 101 to start the read-ahead process if the storage device 101 senses the read of a specific application.

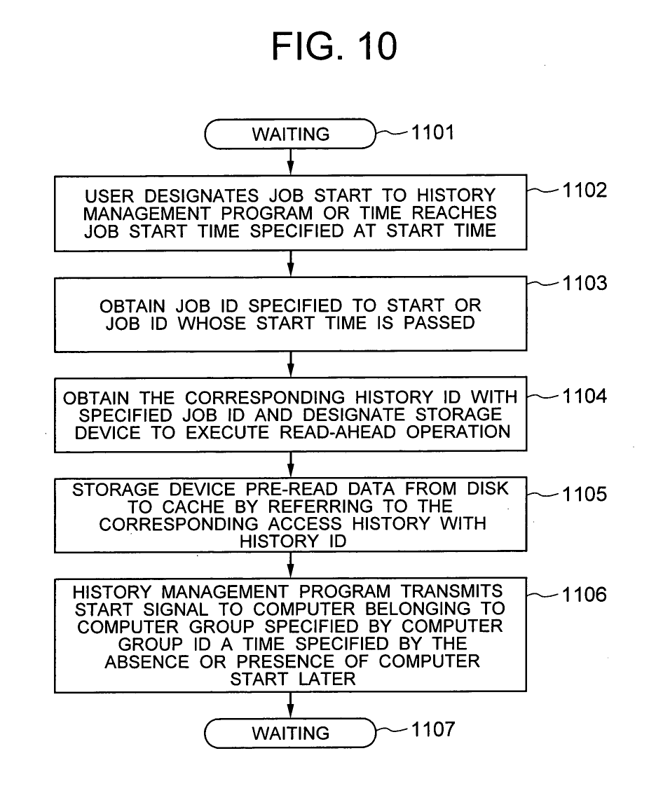

FIG. 10 is a flowchart showing a process of causing the management computer 108 to designate the storage device 101 to execute the job through the history management program. The management computer 108 in the waiting state (step 1101) starts the job when the administrator designates the job start or the current time reaches the time indicated in the start condition of the job management table. Hence, the management computer 108 is constantly checking if the current time reaches the start time of the job registered in the job management table (step 1102).

When the management computer 108 detects the job start designation or that the time reaches the predetermined time, the management computer 108 obtains a job ID of the job designated by the administrator or the job ID of the job whose start time comes from the job management table (step 1103). Afterwards, the management computer 108 obtains the computer ID and the history ID of the job management table corresponding with the obtained job ID, specifies the obtained computer ID and history ID, and then designates the storage device 101 to start the read-ahead process (step 1104).

The storage device 101 selects from the history information list 302 the corresponding access history with the computer ID and history ID specified by the management computer 108 and executes the read-ahead of data to the cache memory based on the history. Herein, if the job includes a plurality of computers IDs or history IDs, the storage device 101 executes the read-ahead process based on the corresponding access history with these plurality of history IDs or computer IDs (step 1105).

Moreover, if the computer start is specified as “yes” in the yes or no of the computer start in the job management table, the management computer 108 obtains from the computer group table the computer ID belonging to the computer group ID a specified time later and then transmits a start signal to each of the computers 111 (step 1106).

As mentioned above, merely by setting the process of designating the read-ahead once, the administrator causes the management computer 108 to automatically designate the read-ahead to the storage device 101. This saves the administrator's burdensome work of designating the read-ahead.

In the foregoing embodiment, the management computer 108 merely designates the scheduled read-ahead. The schedule may include the designation of collecting the access history. In this case, the job management table includes as a new item a field in which registered is the content to be designated to the storage device 101, for example, the designation of starting collection of the access history.

It should be further understood by those skilled in the art that although the foregoing description has been made on embodiments of the invention, the invention is not limited thereto and various changes and modifications may be made without departing from the spirit of the invention and the scope of the appended claims.

1. A storage device having a capability of learning access patterns, comprising:
a control unit;
a cache memory; and
a disk device;
wherein said control unit records a data readout location in the disk device as a history for each computer, respectively reading out data from said storage device, based on predetermined information, and then pre-reads data to be used by a computer from said disk device to said cache memory, based on a command containing information for specifying said history and information for specifying said computer that uses said storage device.

2. A storage device according to claim 1, wherein said predetermined information is for specifying said computer and for specifying said recorded history, and
said control unit records said history as being linked with said information for specifying said history and said information for specifying said computer and, when said command containing said information for specifying said computer and said information for specifying said history is received, reads data from said disk device to said cache memory, based on said history linked with said information for specifying said computer and said information for specifying said history contained in said command.

3. A storage device according to claim 2, wherein said predetermined information includes information on time, and said control unit records said history as being linked with information for specifying said history and information for specifying said computer until a predetermined time.

4. A storage device according to claim 3, wherein said predetermined information includes information for specifying a data storage location of said disk device, and said control unit records said history as being linked with said information for specifying said history and said information for specifying said computer from a time when said computer specified by said information for specifying said computer reads out data stored at a data storage location of said specified disk device.

5. A storage device according to claim 4, wherein when a command of stopping record of said history is received, the record of said history is stopped.

6. A storage device according to claim 5, wherein said control unit receives information for specifying a data storage location of said disk device when said command is received and reads out data from said disk device to said cache memory, based on said history linked with said information for specifying said computer and said information for specifying said history contained in said command from a time when the data stored at the data storage location of said specified disk device is read by said computer specified by said information for specifying said computer.

7. A storage device according to claim 4, wherein an operating system program to be used by said specified computer is stored in a location specified by the information for specifying the data storage location of said disk device.

8. A storage device according to claim 6, wherein an operating system program to be used by said specified computer is stored in a location specified by the information for specifying the data storage location of said disk device.

9. A storage device according to claim 1, wherein the history is arranged to be recorded in a form of a table specifying a relationship among a history ID, the data readout location and the computer using the data having been stored in the location.

10. A system including a storage device having a disk device and a cache memory, a management computer, and a plurality of computers, comprising:
said management computer for transmitting to said storage device a first command containing information for specifying any one of said computers and information for specifying a history;
said storage device for, when the computer specified by said first command reads out data from said storage device, reading a storage location of said data in said disk device as a history as being linked with information for specifying said history and information about said computer to be specified contained in said first command;
said management computer for transmitting to said storage device a second command containing information for specifying any one of said plurality of computers and information for specifying said history; and
said storage device for reading out data specified by said history from said disk device to said cache memory, based on said second command received from said management computer.

11. A system according to claim 9, wherein said management computer includes information about a schedule of a designation to be transmitted to said storage device by said computer itself, and said management computer transmits said first command or second command to said storage device based on said schedule.

12. A system according to claim 10, wherein said management computer designates said specified computer to start said specified computer itself after said second command is transmitted to said storage device.

13. A read-ahead method to be executed in the storage device, comprising the steps of:
transmitting to said storage device a first command containing information for specifying a computer that uses said storage device and a history to be used for said read-ahead;
in said storage device,
recording a location where said data is to be stored as a history as being linked with information for specifying said history and information for specifying said computer contained in said command when said specified computer reads out data from said storage device;
transmitting a second command containing information for specifying said computer and information for specifying said history to said storage device;
in said storage device,
pre-reading data from a recording medium included in said storage device, based on said recorded history corresponding with said information for specifying said computer and said information for specifying said history contained in said second command.

14. A read-ahead method according to claim 12, further comprising the steps of:
transmitting information about time to said storage device; and
recording said history until the time specified by said information about time in said storage device.

15. A read-ahead method according to claim 12, further comprising the step of:
recording said history from a time specified by said information about time in said storage device, based on said information about time.

16. A system according to claim 10, wherein said management computer classifies said plurality of computers into a plurality of groups when registering said computers.
